(19) United States
(12) Patent Application Publication
(10) Pub. No.: US 2024/0003280 A1
(43) Pub. Date: Jan. 4, 2024

(54) METHOD AND DEVICE FOR METERING AN AQUEOUS UREA SOLUTION

(71) Applicant: Vitesco Technologies GmbH, Regensburg (DE)

(72) Inventors: Tobias LUEBBERT, Köln (DE); Peter BAUER, Bonn (DE); Cornelius KÖHLER, Hürth (DE); Youness IDAR, Freyming-Merlebach (DE)

(21) Appl. No.: 18/265,050

(22) PCT Filed: Nov. 30, 2021
(86) PCT No.: PCT/EP2021/083502

§ 371 Date: Jun. 2, 2023

(30) Foreign Application Priority Data
Dec. 3, 2020 (DE) 10 2020 215 263.2

(51) Int. Cl. F01N 3/20

(52) U.S. Cl. CPC F01N 3/208; F01N 2610/144; F01N 2610/146; F01N 2610/1493; F01N 2610/02; F01N 2900/1808

(57) ABSTRACT

A method and device for controlling a delivery device for an aqueous urea solution in a motor vehicle, with a tank, with a suction line, with a pump, with a pressure line, and with an injector, wherein the aqueous urea solution can be conveyed from the tank along the suction line, through the pump, through the pressure line, and to the injector. The method performs a rinsing procedure of at least the pressure line, wherein the pump is operated counter to its usual conveying direction during the rinsing procedure and the injector is closed in a first phase of the method, wherein the pump is operated for an operating duration t1 and at a speed of rotation n1 during the first phase of the method.

### CROSS REFERENCE TO RELATED APPLICATIONS

This is a U.S. national stage of Application No. PCT/EP2021/083502 filed Nov. 30, 2021. Priority is claimed on German Application No. DE 10 2020 215 263.2 filed Dec. 3, 2020 the content of which is incorporated herein by reference.

### BACKGROUND OF THE INVENTION

### 1. Field of the Invention

The disclosure relates to a method for controlling a delivery device for an aqueous urea solution in a motor vehicle, with a tank, a suction line, a pump, a pressure line, and an injector, wherein the aqueous urea solution can be delivered from the tank along the suction line, through the pump, through the pressure line, and to the injector, wherein the method is designed to perform a rinsing procedure of at least the pressure line, wherein the pump is operated counter to its usual delivery direction during the rinsing procedure and the injector is closed in a first phase of the method, wherein the pump is operated for an operating duration t1 and at a speed of rotation n1 during the first phase of the method. The disclosure also relates to a device for carrying out the method.

### 2. Description of the Related Art

In many countries all around the world, legal regulations have been made that define an upper limiting value for the content of specific substances in the exhaust gas from internal combustion engines. These are mostly substances of which the discharge into the environment is undesirable. One of these substances is represented by nitrogen oxide (NOx), of which the proportion in the exhaust gas must not exceed legally defined limiting values. Because of the boundary conditions, for example the design of the internal combustion engines with a view to beneficial consumption and the like, the internal engine avoidance of the nitrous oxide emissions when reducing the proportion of the nitrogen oxides in the exhaust gas is possible only to a limited extent, so that exhaust gas post-treatment is necessary to comply with relatively low limiting values. It has proven to be the case here that selective catalytic reduction (SCR) of the nitrous oxides is advantageous. These SCR methods need a reducing agent which contains nitrogen. In particular, the use of ammonia (NH3) as a reducing agent has emerged as a possible alternative. Because of the chemical properties and the legal provisions in many countries, the ammonia is usually not kept as pure ammonia, since this can lead to problems in particular in motor vehicles or other mobile applications. Rather, instead of storing the reducing agent itself, reducing-agent precursors are often stored and carried along. A reducing-agent precursor is to be understood to mean in particular a substance which splits off the reducing agent or which can be converted chemically into the reducing agent. For example, urea represents a reducing-agent precursor for the reducing agent ammonia.

The aqueous ammonia solution, the urea, is carried along in a tank and delivered into the exhaust gas tract in accurately metered quantities by a suitable delivery device. For this purpose, the aqueous ammonia solution is delivered along a pressure line from the delivery device to an injector. The aqueous urea solution is finally introduced into the exhaust gas tract by the injector and is thermally converted into ammonia and water there in order then to effect the reduction of the nitrous oxides contained in the exhaust gas.

In addition to other functionalities, a rinsing function is implemented in the delivery device in order to rinse the delivery line and free it of any residues of the aqueous ammonia solution. For this purpose, for example in the case of a closed injector, a reduced pressure is generated in the pressure line by the pump of the delivery device being operated counter to the normal delivery direction. As a result of opening the injector after generating a reduced pressure in the pressure line, the aqueous ammonia solution still situated in the pressure line is finally sucked back in the direction of the tank. The rinsing can additionally also be assisted by the operation of the pump.

A disadvantage of the solutions in the prior art is in particular that the rinsing procedure is not variable and thus in particular cannot be adapted because of changes in the overall system, for example wear of the pump.

### SUMMARY OF THE INVENTION

An object of one aspect of the present invention is a method that enables the rinsing procedure to be adapted depending on state variables of the device such as, for example, the age of the pump or the flow rate of the pump. It is also an object of one aspect of the invention to provide a device for carrying out the method.

An exemplary aspect relates to a method for controlling a delivery device for an aqueous urea solution in a motor vehicle, with a tank, with a suction line, with a pump, with a pressure line, and with an injector, wherein the aqueous urea solution can be delivered from the tank along the suction line, through the pump, through the pressure line, and to the injector, wherein the method is designed to perform a rinsing procedure of at least the pressure line, wherein the pump is operated counter to its usual delivery direction during the rinsing procedure and the injector is closed in a first phase of the method, wherein the pump is operated for an operating duration t1 and at a speed of rotation n1 during the first phase of the method, wherein, in this first phase, a reduced pressure p1 directly dependent on the operating duration t1 and the speed of rotation n1 is generated in the pressure line, wherein the operating duration t1 and the speed of rotation n1 are fixed depending on a calibration procedure which is performed when the device is started up for the first time, and they and the resulting reduced pressure p1 are saved in a memory of the device, wherein, in a second phase of the method, the injector is opened and the pump continues to be operated counter to its usual delivery direction.

The operating duration of the pump and its speed of rotation determine the amount of fluid that can be delivered by the pump. An increased speed of rotation or an extended operating duration result in a higher delivery rate. Because, in the first phase, the pump delivers the aqueous urea solution situated in the pressure line and the air which may be situated in the pressure line away from the closed injector at the end of the pressure line, a reduced pressure is generated in the pressure line. The longer that the pump is operated for and the faster the pump rotates, the higher the reduced pressure generated thereby can become.

Properties such as the compressibility of the fluids situated in the pressure line, the inner volume of the pressure line, the leaktightness of the device furthermore influence the maximum achievable reduced pressure. For a specific device, it can be assumed that the volume of the pressure line and the leaktightness of the device are unalterable such that these factors are less relevant for generating the reduced pressure over the lifetime of the device. The creation of the reduced pressure is primarily determined by the speed of rotation of the pump and the operating duration of the pump. Further important influencing variables for creating the reduced pressure are, for example, the change in performance of the pump over the lifetime and differences in performance between pumps with fundamentally the same structure because of unavoidable manufacturing tolerances.

The generated reduced pressure in the first phase can, in the case of a known device, be predicted precisely by the operating duration of the pump and the speed of rotation because the creation of the reduced pressure is influenced substantially by these two variables. However, the pressure in the pressure line can be calculated more accurately by a pressure sensor which preferably enables the pressure prevailing in the pressure line to be calculated correctly at any time. The pressure sensor is preferably designed to detect the reduced pressure occurring in the first phase and to detect elevated pressures such as occur, for example, when the aqueous urea solution is sprayed into the exhaust gas tract by the injector.

The rinsing procedure of the device is divided into two phases. In the first phase, the injector is closed and the pump delivers counter to its usual delivery direction. The usual delivery direction of the pump is such that aqueous urea solution is delivered from the tank into the pressure line and to the injector. The phrase counter to the usual delivery direction means that the aqueous urea solution is delivered from the pressure line to the tank. This is achieved by reversing the direction of the direction of rotation of the pump stage of the pump.

Because the injector is closed in the first phase, the pump can deliver aqueous urea solution from the pressure line in the direction of the tank and also deliver air out of the pressure line. However, because no fluid can flow through the injector into the pressure line, a reduced pressure is generated in the pressure line. This is similar to the principle of pulling apart an air pump when the valve opening is blocked.

In the second phase, the injector is finally opened such that a fluid can flow from the exhaust gas tract into the pressure line. In this second phase, the pump preferably further delivers counter to its usual delivery direction. By virtue of fluid flowing into the pressure line and the further delivery action of the pump, the fluid contained in the pressure line, which can be both air and the aqueous urea solution, is delivered in the direction of the tank. The more pronounced the reduced pressure was before the opening of the injector and the faster and longer the pump delivers, the more fluid is delivered from the pressure line in the direction of the tank.

The pressure line is preferably free of the fluid whilst, however, the suction line and the pump, in particular the pump stage, are not completely free of the fluid.

The values, depending on the respective specific device, for the operating duration t1 and the speed of rotation n1 of the pump are preferably calculated in a so-called “end of line” check which is performed after the device has been mounted in the vehicle in order to test the functionality. During this check, a calculation is made as to for how long and at what speed the pump has to be operated in order to generate the desired reduced pressure p1. The values calculated here for the operating duration t1 and the speed of rotation n1 are saved in a memory of the system. A calculation is made, and the results saved, as to for how long and at what speed the pump has to be operated in the case of a known device in its delivered condition in order to generate the desired reduced pressure.

Because the device is also subject to certain ageing over its lifetime, it is not certain that an operating duration defined at the beginning results in the same desired reduced pressure in the case of a fixed speed of rotation and also in the case of a device that is already aged. The pump is in particular subject to ageing. The delivery capacity of the pump can be affected by wear or dirt. The delivery rate can thus decrease with an identical speed of rotation and operating duration. In order to compensate for this effect, the method according to the invention must be configured accordingly.

It is particularly advantageous if, in the case of at least a starting procedure following start-up for the first time, a rinsing procedure is performed, wherein the reduced pressure p2 in the pressure line and then generated in the first phase of the rinsing procedure is detected and compared with the reduced pressure p1 which results from the operating duration t1 saved in the memory and from the speed of rotation n1.

The rinsing procedure can be performed once, at fixed intervals, or each time the pump or the device is started. The reduced pressure which results in the pressure line in the case of these boundary conditions is here calculated on the basis of values, saved in the memory, for the operating duration and the speed of rotation.

If the generated reduced pressure p2 corresponds to the originally desired reduced pressure p1, no adaptation needs to take place. However, if the reduced pressure p2 is lower and hence less reduced pressure is generated with constant operating conditions of the pump, a corresponding adaptation using the method according to the invention has to take place in order to enable operation of the device.

For this purpose, it is advantageous if a comparison of the reduced pressures p1 and p2 is performed, wherein a correction factor K1, by which the operating duration and/or the speed of rotation is adapted from the value t1 and/or n1 to a value t2 and/or n2, is calculated depending on the deviation between the reduced pressure p1 and the reduced pressure p2.

Detection of the reduced pressures and comparison thereof can preferably be performed in a calculation unit, for example a control unit.

If the reduced pressure p2 is lower than the reduced pressure p1, extension of the operating duration must be initiated and/or an increase in the speed of rotation in order to ensure that the reduced pressure p2 approaches the level of p1 and ideally becomes identical to this reduced pressure p1. The operating parameters of the pump are therefore according to the invention computed by a correction factor K1 calculated from the comparison and thus new operating parameters are saved in the memory for further operation.

In the case of future rinsing procedures, a comparison with the reduced pressure p1 and the operating parameters underlying this reduced pressure can furthermore take place, or a comparison with the reduced pressure p2 achieved after the correction.

This relates in particular to the operating parameters such as the operating duration and the speed of rotation. Because the changes to the device which cause a change in the reduced pressure are generally not reversible, it can be assumed that the reduced pressure p2 generated with the newly found operating parameters t2 and n2 can in future also be achieved only by a further correction of the operating parameters.

A preferred exemplary aspect is characterized in that, during the second phase of the method, by virtue of the reduced pressure generated and the continued operation of the pump counter to its usual delivery direction, rinsing of the pressure line is achieved, wherein fluids situated in the pressure line are delivered in the direction of the suction line to the tank. The pressure line is here preferably as far as possible emptied of fluids. It is, however, desirable that not the whole device and in particular not the suction line and the pump stage are completely emptied in order to avoid the pump running dry.

It is also preferred if the correction factor K1 which is calculated depending on the deviation between the reduced pressure p1 and the reduced pressure p2 is used in order to adapt the operating duration t3 of the pump and/or the speed of rotation n3 during the second phase of the method.

Because of the abovedescribed ageing and wear of the device, it may also be necessary to increase the operating duration and the speed of rotation in the second phase in order to deliver a greater amount of fluid from the pressure line.

It is furthermore advantageous if a third phase is added after the first phase and the second phase, wherein in the third phase the pump is operated in its usual delivery direction and hence an elevated pressure is generated in the pressure line, wherein the operating duration t4 and/or the speed of rotation n4 of the pump in this third phase is altered by the calculated correction factor K1 from an original value.

The third phase represents the build-up of pressure in the pressure line. Aqueous urea solution is delivered from the tank into the pressure line by operating the pump in its usual delivery direction.

Because the wear of the pump influences the delivery capacity in its usual delivery direction to the same extent as counter to its usual delivery direction, the operating duration t4 and/or the speed of rotation n4 are also adapted by the correction factor K1 in order to ensure that a sufficient elevated pressure is built up in the pressure line.

It is furthermore advantageous if a fourth phase is added after the first phase and the second phase of the method, wherein the third phase follows the fourth phase or method ends after the fourth phase, wherein during the fourth phase the injector is closed and the pump operated counter to its usual delivery direction for an operating duration t5 at a speed of rotation n5.

The fourth phase described here corresponds to the first phase of the already described rinsing procedure. A reduced pressure p5 is built up again in the pressure line with the injector closed. For this purpose, the pump is operated counter to its usual delivery direction for the operating duration t5 at a speed of rotation n5.

It is also expedient if a reduced pressure p5 in the pressure line is calculated and a comparison with the reduced pressure p1 saved in the memory is carried out, wherein the ratio of the reduced pressure p5 to the reduced pressure p1 allows a direct conclusion to be drawn about the air remaining in the pressure line and the amount of aqueous urea solution remaining in the pressure line.

Comparison of the reduced pressure p5 generated in the fourth phase with the reduced pressure p1 saved in the memory allows a direct conclusion to be drawn about the amount of aqueous urea solution contained in the pressure line and the air contained there. This follows directly from the physical properties of gases and liquids, wherein gases, in this case air, have a higher compressibility than liquids. An accurate conclusion can be drawn about the amounts of fluid situated in the pressure line from the ratio between the two reduced pressures, assuming other known conditions.

With the same speed of rotation of the pump and the same run time, the achievable reduced pressure in the pressure line is dependent on the ratio of the liquid situated in the pressure line and the gas situated in the pressure line. In the ideal extreme case, the pressure line is filled, for example, completely with liquid. In the least favorable extreme case, the pressure line is filled completely with gas.

It is then possible, for a specific pressure line with a given length and a given volume, for a maximum achievable reduced pressure to be calculated in the case of defined operating conditions experimentally for each ratio of liquid to gas. The values thus calculated can be saved in a memory unit such that a conclusion can then be drawn in operation from the calculated reduced pressure p5 in the pressure line about the respective ratio of gas to liquid.

It is furthermore advantageous if the amount of aqueous urea solution actually remaining in the pressure line is computed after the fourth phase is completed, wherein for this purpose the reduced pressure p5, the operating duration t5 of the pump, the speed of rotation n5 of the pump, the static flow rate of the injector, and the internal volume of the pressure line are used.

The amount of aqueous urea solution actually situated in the pressure line is preferably computed by the maximum volume of the pressure line, the static flow rate of the injector, and the time for which the injector is open being used. The maximum line volume is known. A specified volume of fluid can, in a defined period of time, flow through an injector in each case by virtue of the static flow rate specific to the injector.

Because reverse delivery by the pump in the direction of the tank is possible, gas will flow from the exhaust gas tract through the open injector into the pressure line. This gas displaces the liquid situated in the pressure line. In the case of a known line volume and known gas sucked into the pressure line through the injector, the volume of the liquid remaining in the pressure line can be computed.

Because the amount of liquid situated in the pressure line at the beginning of the procedure can be delivered only in the direction of the tank from the pressure line, when the length of the pressure line and the volume of the pressure line are known with a known amount of gas which has been sucked into the pressure line, a conclusion can be drawn as to to what extent the gas has been sucked into the pressure line and consequently where the phase boundary between the gas and the liquid is in the pressure line.

It is furthermore expedient if the amount of aqueous urea solution remaining in the pressure line calculated by comparison of the reduced pressures p5 and p1 is compared with an amount of aqueous urea solution remaining in the pressure line calculated according to the abovedescribed method, wherein, when a fixed maximum differential value between the two amounts is exceeded, a correction factor K2 is generated by which the duration of the first phase and/or the second phase of the method is corrected.

The length of the rinsing procedure which consists of the first phase and the second phase is extended overall by the correction factor K2. This results in more fluid being delivered out of the pressure line overall.

Because the fluid still situated in the pressure line and in particular the amount of aqueous urea solution are computed, it is possible to calculate to what extent the aqueous urea solution inside the pressure line has been drawn toward the pump. This is due to the fact that the amount of aqueous urea solution and the amount of air in the pressure line, and the position of the liquid inside the pressure line are directly correlated with each other in the case of a known volume of the pressure line. It can consequently in particular be prevented that the aqueous urea solution is delivered out of the pressure line to such an extent that the pump stage becomes dry and dry running of the pump could thus occur.

Knowing the precise amount of air which is present in the pressure line furthermore also makes it possible to optimize so-called priming in which the air contained in the pressure line is pushed out of the pressure line by the operation of the pump in its usual delivery direction with the injector open. The metering strategy can thus be improved because, by virtue of the known capacity of the pump, it is known precisely how long it takes to deliver a specified amount of air from the pressure line. Because the air situated in the pressure line is known and the time needed to deliver this air from the pressure line is known, it is possible to determine precisely when the pressure line is vented and the actual metering of the aqueous urea solution into the exhaust gas tract can be started.

It is also expedient if a comparison of the reduced pressures p1 and p2 is performed, wherein a correction factor K3 is calculated depending on the deviation between the reduced pressure p1 and the reduced pressure p2, wherein the correction factor K3 is subsequently used to adapt the operating duration t4 or the speed of rotation n4 in the third phase.

In particular, the dry running of the pump can be detected by the comparison because, when the pump is running dry, it is not possible to build up a significant reduced pressure in the pressure line. If dry running is detected, the correction factor K3 is used to increase the operating duration t4 and/or the speed of rotation n4 in the third phase so that it is ensured that sufficient fluid is sucked from the tank and a sufficient venting of the pressure line thus takes place and a desired elevated pressure can consequently be generated in the pressure line.

An exemplary aspect of the invention relates to a device for delivering an aqueous urea solution in a motor vehicle, with a tank, with a suction line, with a pump, with a pressure line, and with an injector, wherein the aqueous urea solution can be delivered from the tank along the suction line, through the pump, through the pressure line, and to the injector, wherein a method as claimed in the preceding claims can be performed with this device, wherein the device has a detector for detecting the pressure in the pressure line.

Advantageous developments of the present invention are described in the dependent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for controlling a delivery device for an aqueous urea solution in a motor vehicle, with a tank, a suction line, a pump, a pressure line, and an injector, comprising:
delivering the aqueous urea solution from the tank along the suction line, through the pump, the pressure line, and to the injector; and
rinsing at least the pressure line, wherein the rinsing comprises:
closing the injector in a first phase;
operating the pump counter to its usual delivery direction during the rinsing for an operating duration t1 and at a speed of rotation n1 in the first phase, wherein, in the first phase, a first reduced pressure p1 directly dependent on the operating duration t1 and the speed of rotation n1 is generated in the pressure line;
fixing the operating duration t1 and the speed of rotation n1 depending on a calibration procedure performed when the device is started up for a first time, and the operating duration t1 and the speed of rotation n1 and the first reduced pressure p1 are saved in a memory of the device; and
opening the injector in a second phase while the pump continues to be operated counter to its usual delivery direction.

14. The method as claimed in claim 13, wherein, in the starting procedure of the pump following start-up for the first time, a rinsing procedure is performed, wherein a second reduced pressure p2 in the pressure line generated in the first phase of the rinsing procedure is detected and compared with the first reduced pressure p1 which results from the operating duration t1 saved in the memory and from the speed of rotation n1.

15. The method as claimed in claim 14, further comprising:
comparing the first and second reduced pressures; and
calculating a correction factor K1, by which a second operating duration and/or a second speed of rotation is adapted from a value t1 and/or n1 to a value t2 and/or n2, depending on a deviation between the first reduced pressure p1 and the second reduced pressure p2.

16. The method as claimed in claim 15, wherein, during the second phase, by virtue of the reduced pressure generated and the continued operation of the pump counter to its usual delivery direction, rinsing of the pressure line is achieved, wherein fluids in the pressure line are delivered in a direction of the suction line to the tank.

17. The method as claimed in claim 16, wherein the correction factor K1 is used to adapt a third operating duration t3 of the pump and/or a third speed of rotation n3 during the second phase.

18. The method as claimed in claim 15, further comprising:
a third phase after the first phase and the second phase, wherein in the third phase the pump is operated in its usual delivery direction and an elevated pressure is generated in the pressure line, wherein a fourth operating duration t4 and/or a fourth speed of rotation n4 of the pump in this third phase is altered by the calculated correction factor K1 from an original value.

19. The method as claimed in claim 18, wherein a fourth phase is added after the first phase and the second phase of the method, wherein the third phase follows the fourth phase or the method ends after the fourth phase, wherein during the fourth phase the injector is closed and the pump operated counter to its usual delivery direction for a fifth operating duration t5 at a fifth speed of rotation n5.

20. The method as claimed in claim 19, wherein a third reduced pressure p5 in the pressure line is calculated and a comparison with the first reduced pressure p1 saved in the memory is carried out, wherein a ratio of the third reduced pressure p5 to the first reduced pressure p1 allows a direct conclusion to be drawn about air remaining in the pressure line and an amount of aqueous urea solution remaining in the pressure line.

21. The method as claimed in claim 20, wherein the amount of aqueous urea solution actually remaining in the pressure line is computed after the fourth phase is completed, wherein for this purpose the third reduced pressure p5, the fifth operating duration t5 of the pump, the fifth speed of rotation n5 of the pump, a static flow rate of the injector, and an internal volume of the pressure line are used.

22. The method as claimed in claim 21, wherein the amount of aqueous urea solution remaining in the pressure line calculated by comparison of the third and first reduced pressures p5 and p1 is compared with an amount of aqueous urea solution remaining in the pressure line calculated in claim 9, wherein, when a fixed maximum differential value between the two amounts is exceeded, a correction factor K2 is generated by which the duration of the first phase and/or a duration of the second phase is corrected.

23. The method as claimed in claim 18, wherein a comparison of the first and second reduced pressures p1 and p2 is performed, wherein a correction factor K3 is calculated depending on a deviation between the first reduced pressure p1 and the second reduced pressure p2, wherein the correction factor K3 is subsequently used to adapt the fourth operating duration t4 or the fourth speed of rotation n4 in the third phase.

24. A device for delivering an aqueous urea solution in a motor vehicle, comprising: a tank, a suction line, a pump, a pressure line, and an injector, wherein the aqueous urea solution is delivered from the tank along the suction line, through the pump, through the pressure line, and to the injector, wherein a method as claimed in claim 13 can be performed with this device, wherein the device has a device configured to detect a pressure in the pressure line.
